(19) United States
(12) Patent Application Publication
(10) Pub. No.: US 2010/0054846 A1
(43) Pub. Date: Mar. 4, 2010

(54) Writing Instrument

(76) Inventor: Brian Hartman, Drobak (NO)

Correspondence Address: The Law Office of Michael E. Kondoudis, 888 16th Street, N.W., Suite 800, Washington, DC, 20006, US

(21) Appl. No.: 12/545,128

(22) Filed: Aug. 21, 2009

Related U.S. Application Data
(60) Provisional application No. 61/092,757, filed on Aug. 29, 2008.

(51) Int. Cl. B43K 8/06; B43K 29/00

(52) U.S. Cl. 401/195; 401/198

(57) ABSTRACT

A writing instrument assembly where the capillary feed device, also referred to as the wick, of the writing instrument is lengthened and can be manipulated in order gain access to a new useful portion of the wick. The writing instrument comprises a reservoir of marking substance and a wick which is in communication with said reservoir for transporting said marking substance to the writing portion of said wick, also known as the tip. The writing instrument includes a cap to close the writing instrument when not in use. The writing instrument further comprises a mechanical device used for accessing the additional wick and a cutting or trimming mechanical device in order to remove the desired portion of wick.

### CROSS-REFERENCE TO RELATED APPLICATION

This application claims the benefit of U.S. provisional patent application No. 61/092,757, filed Aug. 29, 2008.

### BACKGROUND

1. Technical Field

Embodiments of the present invention relate generally to writing instruments and, more particularly, to a marker and/or pen assembly with a renewable writing tip.

2. Description of Related Art

A pen is a writing instrument used to apply ink to a surface, usually paper. There are several different types of pens, including ballpoint, fountain, and felt-tip. The latter type is also known as a marker.

Felt-tip pens or markers have a porous writing tip composed of fibrous material called a wick. This wick need not be made of felt and is commonly manufactured from a fibrous material that is suitably firm and can suitably absorb the marking substance (ink) and transport it to the writing tip of the wick.

Felt-tip pens, or markers, are used in a variety of applications. The smallest, finest-tipped markers are used for writing on paper. Medium-tip markers are often used by children for coloring. Larger markers are used for writing on other surfaces such as cardboard boxes and whiteboards. Markers with wide tips and bright but transparent ink, called highlighters, are used to mark existing text.

Felt-tip pens may vary in design but share similar functionality. They also suffer from the same disadvantages, including not working well or at all when the tip is dry, soiled or damaged, regardless of the amount of marking substance (ink) remaining in the pen. For instance, when children use their markers and pens to draw, they often forget to replace the cap, or the cap is replaced improperly, permitting the writing tip to dry out. Once dried, damaged or soiled, the writing tip of the wick of the marker loses the ability to transport ink through the writing tip to the writing surface. This requires replacement of the writing instrument, even though there may be more ink available in the cartridge or the pen.

### BRIEF SUMMARY

According to an aspect of the present invention, there is provided a writing instrument characterized by a lengthened wick for enabling a user to replace the portion of the wick constituting the writing tip. The writing instrument includes: a body containing a reservoir for a marking substance, usually of liquid form; a lengthened wick, also referred to as the capillary feed device, for transferring the marking substance to the writing tip; and a screw-type mechanism to reel said additional wick out from within the body for replacement of the writing tip, and a cap comprising a cutting or pinching mechanism to trim the extended writing tip of the wick.

According to another aspect of the present invention, there is provided a writing instrument, including: a body including a wick extending mechanism at a first end and a reservoir at a second end opposite the first end; a wick substantially surrounded by the body, selectively extendable by the wick extending mechanism, and including a writing tip at a first end of the wick and a pick up end at a second end of the wick opposing the first end, the writing tip of the wick extending beyond the body at the first end of the body, the pick up end of the wick extending into the reservoir and picking up liquid from the reservoir; and a writing tip manager that trims the writing tip when the writing tip is selectively extended by the wick extending mechanism so that the writing tip extends into a hole of a cap that is placed on the writing instrument so that the writing tip is appropriately dimensioned for writing.

According to still another aspect of the present invention, there is provided a pen, including: an extendable wick having a writing tip at an extended end; a wick feeder that selectively feeds the wick so as to extend the extendable end of wick beyond a body of the pen; and a cap having a writing tip trimmer that trims the extendable end of the wick when the cap is placed on the body of the pen and the wick is extended beyond a threshold length required for writing.

According to yet another aspect of the present invention, there is provided a method of maintaining the wick of a pen, including: providing a pen having a body including a wick extending mechanism at a first end and a reservoir at a second end opposite the first end, a wick substantially surrounded by the body, selectively extendable by the wick extending mechanism, and including a writing tip at a first end of the wick and a pick up end at a second end of the wick opposing the first end, the writing tip of the wick extending beyond the body at the first end of the body, the pick up end of the wick extending into the reservoir and picking up liquid from the reservoir, and a cap with a writing tip trimmer; selectively extending the wick via the wick extending mechanism; and trimming the writing tip by placing a cap on the body after the wring tip is selectively extended by the wick extending mechanism and activating the writing tip trimmer so that the writing tip is appropriately dimensioned for writing and delivering liquid from the reservoir.

These, additional, and/or other aspects and/or advantages of the present invention are: set forth in the detailed description which follows; possibly inferable from the detailed description; and/or learnable by practice of the present invention.

### BRIEF DESCRIPTION OF THE DRAWINGS

The present invention will be more readily understood from the detailed description of embodiments thereof made in conjunction with the accompanying drawings of which:

FIG. 1. is a perspective view of a writing instrument according to an embodiment of the present invention;

FIG. 2. is a perspective view of an extendable tip according to an embodiment of the present invention; and

FIG. 3. is a perspective view of a cutting or trimming cap according to an embodiment of the present invention.

### DETAILED DESCRIPTION

Reference will now be made in detail to embodiments of the present invention, examples of which are illustrated in the accompanying drawings, wherein like reference numerals refer to the like elements throughout. The embodiments are described below to explain the present invention by referring to the figures.

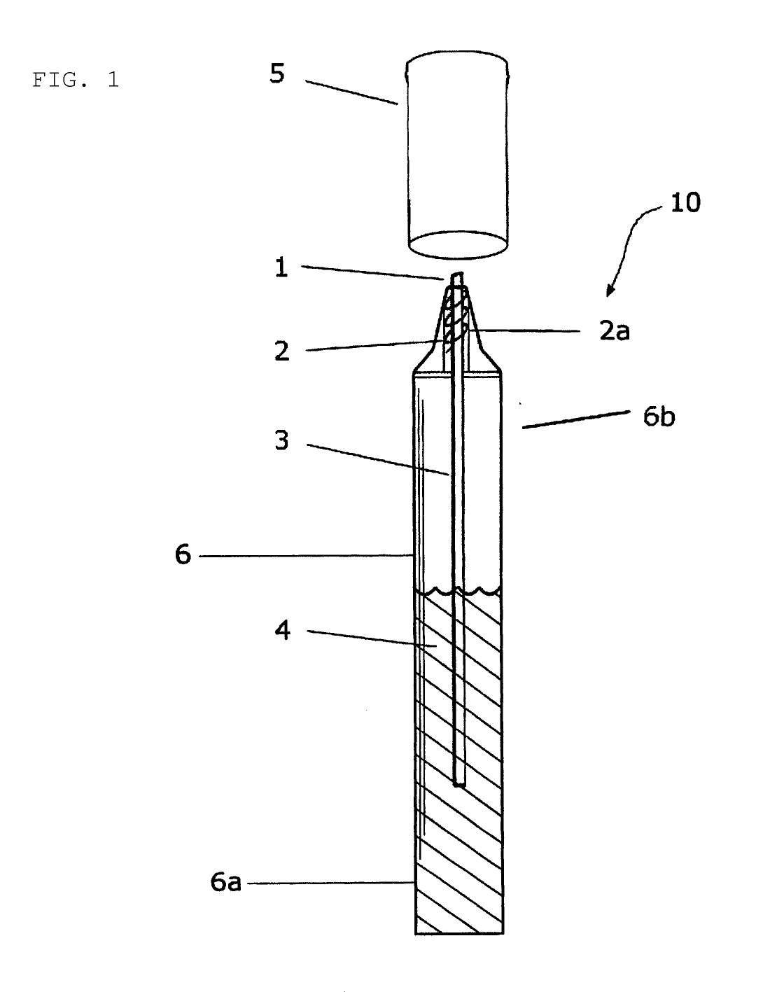

Referring to FIG. 1, there the illustrated a writing instrument 10 according to an embodiment of the present invention. The writing instrument 10 includes a top portion 2, a wick 3, ink 4, a removable cap 5, and a body 6. The cap 5, the top portion 2, and the body 6 constitute the outer surface of the writing instrument 10.

The body 6 includes a reservoir end 6a and an opposing end 6b to which the top portion 2 is attached. The ink 4 is retained in the reservoir end 6a.

The wick 3 includes the writing tip 1 and a lengthened body portion 3a extending into the writing instrument 10 so as to be in communication with the reservoir. In more detail, the wick 3 extends from the reservoir end 6a through the top portion 2 such that a portion (writing tip 1) of the wick 3 extends beyond the top portion 2. In use, the wick 3 transports the marking substance 4 (ink) from the reservoir end 6a to the writing tip 1 where it is delivered to a writing surface.

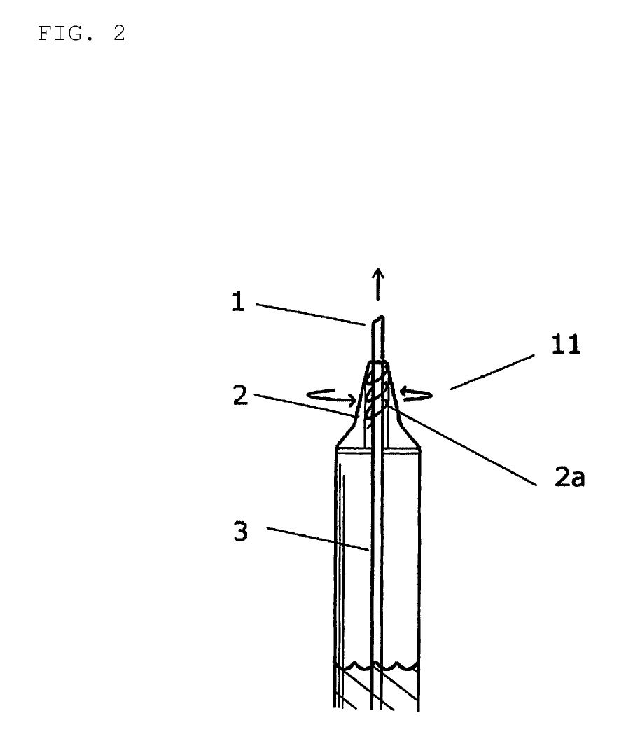

The wick 3 and the top portion 2 comprise a wick extending mechanism 11 by which the wick 3 is selectively extendable (extruded) so that the length of the writing tip 1 is increased. As illustrated in FIG. 2, the wick extending assembly may be a twist-type mechanism that allows the user to reel out the additional wick. When a twist-type mechanism is used, the top portion 2 is attached to, yet can revolve independently from, the bottom portion 6.

Also, when a twist-type mechanism is used, the revolving top portion 2 includes a thread assembly 2a on the inside that grips and pulls the additional wick from within the body 6 of the writing instrument. It is to be understood, however, that the selective extension of the wick need not be achieved by the illustrated mechanism. Indeed, it may be accomplished in any variety of ways, including by way of non-limiting examples, a dial or wheel mechanism built into the writing instrument. This extension can also be carried out by a lever or button mechanism built into the writing instrument, or by squeezing a portion of the writing instrument, or by pushing or gripping a portion of the writing instrument or cap, such that the wick is reeled, pushed or pulled out of the writing instrument.

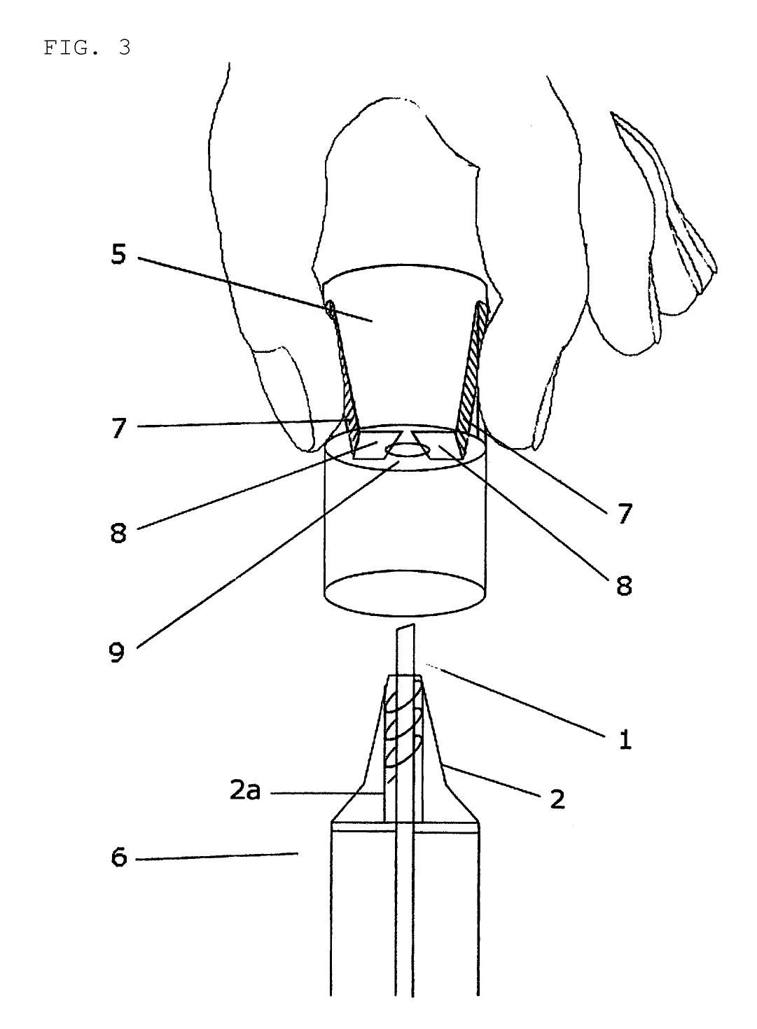

Referring now to FIG. 3, the cap 5 of the present embodiment is illustrated in more detail. The cap 5 includes: one or more one or more grip areas 7 each with a free end and a hinged end; and cutting portions 8 movably disposed around a hole 9. The cutting portions 8 are attached to the free ends of the grip areas 7. When inward pressure is applied to the grip areas 7, the free ends of the grip areas 7, as well as the cutting portions 8 attached to the free ends, travel inwardly toward each other.

The cutting portions 8 contained in the cap 5 cut the writing tip 1 by a pinching action in the cap. In more detail, when the cap 5 is placed on the pen 10, and the writing tip 1 has been extended (extruded) beyond a threshold suitable for writing such that it extends into the opening 9 when the cap 5 is placed on the writing instrument, pressing the grip areas 7 brings the cutting portions 8 together to trim the writing tip 1. This enables the user to remove the dried, or otherwise unusable, portion of the wick 3, constituting the writing tip 1, in order to gain access to the fresh, usable portion of the wick.

Although the cutting portions 8 are illustrated as blades, it is to be understood that the cutting portion may be, by way of non-limiting examples, pincers or scissors. It is also to be understood that the manipulation/management of the wick 3 may be carried out by other methods, including by way of non-limiting examples, cutting and/or trimming, folding or breaking devices built into the marker assembly or cap. Furthermore, in order to ease the manipulation of the wick, depending on the production method chosen, the wick may be manufactured segmented, portioned, perforated, marked or the like, resulting in the wick being more easily manipulated, including having predetermined lengths. Of course, this method may carried out using other pens.

In an exemplary embodiment of the present invention, there is a method of maintaining the wick of a pen. The method includes: providing a pen as described herein; selectively extending the wick via the wick extending mechanism; and trimming the writing tip by placing a cap on the body after the wring tip is selectively extended by the wick extending mechanism and activating the writing tip trimmer so that the writing tip is appropriately dimensioned for writing and delivering liquid from the reservoir.

As described above, by selectively operating the wick extending mechanism 11, the wick 3 can be lengthened, enabling replacement of the writing portion 1 of the wick 3 when it has been rendered unusable. Also, the extendable and manipulable wick 3 enables further utilization of the marking substance (ink 4) contained within by allowing the replacement of the writing tip 1 when it is rendered unusable.

Although selected embodiments of the present invention have been shown and described, it is to be understood the present invention is not limited to the described embodiments. Instead, it is to be appreciated that changes may be made to these embodiments without departing from the principles and spirit of the invention, the scope of which is defined by the claims and the equivalents thereof.

I claim:

1. A writing instrument characterized by a lengthened wick for enabling a user to replace the portion of the wick constituting the writing tip, the writing instrument comprising:
a body containing a reservoir for a marking substance, usually of liquid form;
a lengthened wick, also referred to as the capillary feed device, for transferring the marking substance to the writing tip; and
a screw-type mechanism to reel said additional wick out from within the body for replacement of the writing tip, and a cap comprising a cutting or pinching mechanism to trim the extended writing tip of the wick.

2. The improvement to a writing instrument according to claim 1, characterized in that the extended wick provided within the body is manufactured of equally absorbent material for continued transferal of the marking substance from the reservoir to the replaced writing tip.

3. The improvement to a writing instrument according to claim 1, characterized in that the extended wick is accessible by a mechanical manipulation of the writing instrument which reels out the additional wick from inside the body.

4. The improvement to a writing instrument according to claim 1, characterized in that the wick is segmented, structurally weakened, and/or marked in order to allow ease in removal of the unusable writing tip.

5. The improvement to a writing instrument according to claim 1, characterized in that the cap comprises a cutting or pinching mechanism to safely trim the desired writing portion of the wick.

6. A writing instrument, comprising:
a body including a wick extending mechanism at a first end and a reservoir at a second end opposite the first end;
a wick substantially surrounded by the body, selectively extendable by the wick extending mechanism, and including a writing tip at a first end of the wick and a pick up end at a second end of the wick opposing the first end, the writing tip of the wick extending beyond the body at the first end of the body, the pick up end of the wick extending into the reservoir and picking up liquid from the reservoir; and
a writing tip manager that trims the writing tip when the writing tip is selectively extended by the wick extending mechanism so that the writing tip extends into a hole of a cap that is placed on the writing instrument so that the writing tip is appropriately dimensioned for writing.

7. A pen, comprising:
an extendable wick having a writing tip at an extended end;
a wick feeder that selectively feeds the wick so as to extend the extendable end of wick beyond a body of the pen; and
a cap having a writing tip trimmer that trims the extendable end of the wick when the cap is placed on the body of the pen and the wick is extended beyond a threshold length required for writing.

8. A method of maintaining the wick of a pen, comprising:
providing a pen including
a body including a wick extending mechanism at a first end and a reservoir at a second end opposite the first end,
a wick substantially surrounded by the body, selectively extendable by the wick extending mechanism, and including a writing tip at a first end of the wick and a pick up end at a second end of the wick opposing the first end, the writing tip of the wick extending beyond the body at the first end of the body, the pick up end of the wick extending into the reservoir and picking up liquid from the reservoir, and
a cap with a writing tip trimmer;
selectively extending the wick via the wick extending mechanism; and
trimming the writing tip by placing a cap on the body after the wring tip is selectively extended by the wick extending mechanism and activating the writing tip trimmer so that the writing tip is appropriately dimensioned for writing and delivering liquid from the reservoir.
